(19) United States
(12) Patent Application Publication
(10) Pub. No.: US 2003/0125047 A1
(43) Pub. Date: Jul. 3, 2003

(54) Method of updating a set of candidate frequency channels during wireless communications between a radio port and a mobile communications device

(75) Inventors: Hsi-Kun Chen, Taoyuan (TW); Yu-Jen Hsueh, Taoyuan (TW)

Correspondence Address: MERCHANT & GOULD PC, P.O. BOX 2903, MINNEAPOLIS, MN, 55402-0903, US

(73) Assignee: SynComm Technology Corp., TAOYUAN (TW)

(21) Appl. No.: 10/213,528

(22) Filed: Aug. 6, 2002

(30) Foreign Application Priority Data
Dec. 31, 2001 (TW) 090133387

(51) Int. Cl. H04Q 7/20

(52) U.S. Cl. 455/456; 455/67.1

(57) ABSTRACT

In a method of updating a set of candidate frequency channels during wireless communications between a radio port and a mobile communications device, the communications device switches to a current measured one of multiple pre-stored frequency channels not in a current set of candidate frequency channels to measure signal quality after an assigned time slot of a current time frame of a second time sequence, and switches back to a current working frequency channel prior to the assigned time slot of a succeeding time frame of a first time sequence. The mobile communications device updates a current set of the candidate frequency channels with the current measured frequency channel when the signal quality attributed to the current measured frequency channel is better than those attributed to the current set of the candidate frequency channels.

### CROSS-REFERENCE TO RELATED APPLICATION

This application claims priority of Taiwan patent Application No. 090133387, filed on Dec. 31, 2001.

### BACKGROUND OF THE INVENTION

1. Field of the Invention

The invention relates to a method of updating a set of candidate frequency channels, more particularly to a method of updating a set of candidate frequency channels during wireless communications between a radio port and a mobile communications device.

2. Description of the Related Art

In a personal access communications system (PACS) 1, as shown in FIG. 1, wireless communications between mobile communications devices (called subscriber units), such as mobile phones 11, can be achieved via radio ports 12 and radio port control units 13 connected to the radio ports 12.

Due to the limited transmission range of the mobile communications devices, a personal access communications system generally provides a service area that consists of a plurality of cells (not shown), each of which is provided with a radio port for data transmission. In order to ensure good signal quality during movement of the mobile communications device from a current cell to another cell, the mobile communications device is provided with a plurality of pre-stored frequency channels having different frequencies within a frequency bandwidth. The mobile communications device selects one of the pre-stored frequency channels having optimum signal quality as a current working frequency channel for bi-directional data transmission with the radio port, and further selects a current set of the remaining pre-stored frequency channels having good signal quality as candidate frequency channels when the mobile communications device is activated. One of the candidate frequency channels is available for use as the working frequency channel when the signal quality of the current working frequency channel worsens.

In a conventional method of updating a set of candidate frequency channels, additional radio frequency module and baseband unit may be employed to measure received signal strength indication (RSSI) and quality indication (QI) of the pre-stored frequency channels, respectively, when updating the set of candidate frequency channels, thereby resulting in relatively high costs.

### SUMMARY OF THE INVENTION

Therefore, the object of the present invention is to provide a low-cost method of updating a set of candidate frequency channels during wireless communications between a radio port and a mobile communications device.

According to the present invention, there is provided a method of updating a set of candidate frequency channels during wireless communications between a radio port and a mobile communications device. The mobile communications device is capable of wireless communications using one of a plurality of pre-stored frequency channels having different frequencies within a frequency bandwidth.

The mobile communications device selects one of the pre-stored frequency channels having optimum signal quality as a current working frequency channel for bi-directional data transmission with the radio port, and further selects a current set of the remaining pre-stored frequency channels having good signal quality as candidate frequency channels when the mobile communications device is activated. One of the candidate frequency channels is available for use as the working frequency channel when the signal quality of the current working frequency channel worsens.

The radio port transmits data to the mobile communications device in accordance with a first time sequence defined with a plurality of time-division-multiplexed time slots in consecutive time frames.

The mobile communications device transmits data to the radio port in accordance with a second time sequence corresponding to the first time sequence.

Data transmission between the radio port and the mobile communications device is accomplished in assigned ones of the time slots of the first and second time sequences.

The method comprises the steps of:

(a) enabling the mobile communications device to switch from the current working frequency channel to a current measured one of the pre-stored frequency channels and to measure signal quality after the assigned one of the time slots of a current one of the time frames of the second time sequence, and to switch from the current measured one of the pre-stored frequency channels back to the current working frequency channel prior to the assigned one of the time slots of a succeeding one of the time frames of the first time sequence;

(b) enabling the mobile communications device to verify whether the signal quality attributed to the current measured one of the pre-stored frequency channels is better than those attributed to the current set of the candidate frequency channels; and

(c) enabling the mobile communications device to update the current set of the candidate frequency channels with the current measured one of the pre-stored frequency channels when the signal quality attributed to the measured one of the frequency channels is better than those attributed to the current set of the candidate frequency channels.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view illustrating a personal access communications system;

FIG. 2 is a schematic circuit block diagram illustrating a mobile communications device used in the preferred embodiment of a method of updating a set of candidate frequency channels during wireless communications between a radio port and the mobile communications device according to this invention;

FIG. 3 is a flow chart illustrating how the mobile communications device is configured to update the set of candidate frequency channels in accordance with the method of the preferred embodiment; and

FIGS. 4a and 4b are time sequence diagrams to illustrate data transmission between the mobile communications device and the radio port.

### DETAILED DESCRIPTION OF THE PREFERRED EMBODIMENT

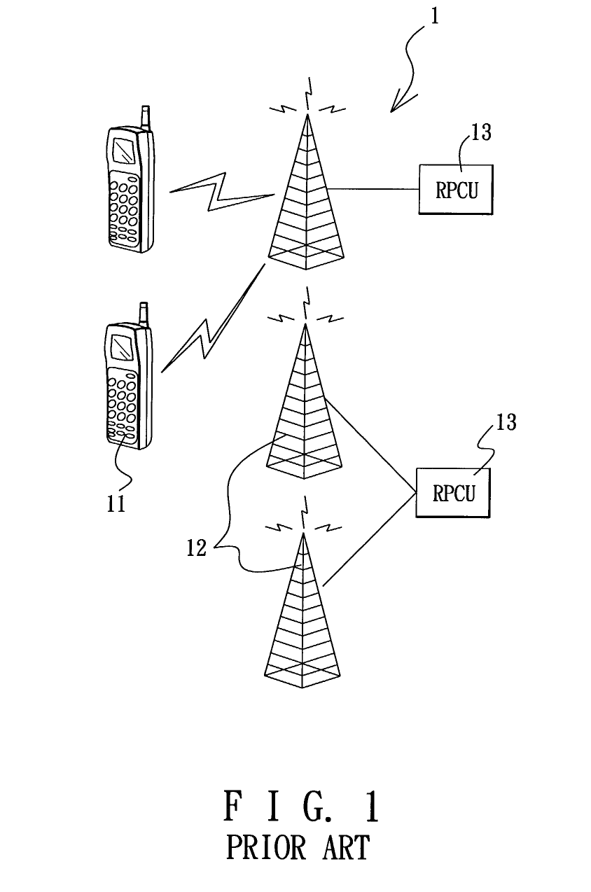

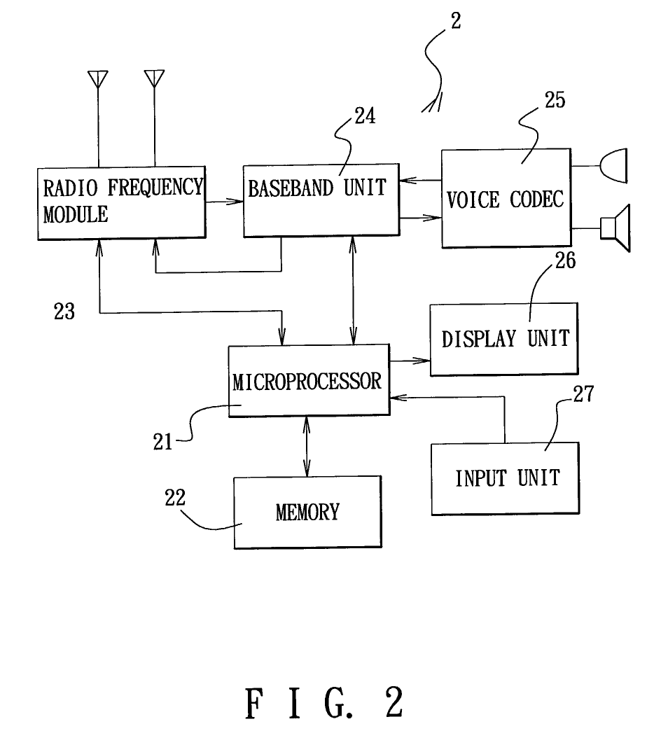

FIG. 2 illustrates a mobile communications device 2, such as a mobile phone, that is configured according to the preferred embodiment of a method of updating a set of candidate frequency channels during wireless communications between a radio port (not shown) and the mobile communications device 2 of the present invention. The mobile communications device 2 includes a radio frequency module 23, a baseband unit 24 connected to the radio frequency module 23, a voice codec 25, a memory 22, an input unit 27, a display unit 26, and a microprocessor 21 connected to the radio frequency module 23, the baseband unit 24, the display unit 26, the memory 22 and the input unit 27. In this embodiment, the mobile communications device 2 is used in a personal access communications system, such as that shown in FIG. 1, and is capable of wireless communications using one of a plurality of pre-stored frequency channels, such as 16 pre-stored frequency channels, having different frequencies within a frequency bandwidth. Each of the pre-stored frequency channels is associated with a specific uplink frequency and a specific downlink frequency in a known manner.

The microprocessor 21 controls the radio frequency module 23 and the baseband unit 24 to scan the pre-stored frequency channels so as to select one of the pre-stored frequency channels having optimum signal quality as a current working frequency channel for bi-directional data transmission with the radio port, and to further select a current set of three of the remaining pre-stored frequency channels having good signal quality as candidate frequency channels when the mobile communications device 2 is activated. As is known in the art, one of the candidate frequency channels is selected for use as the working frequency channel when the signal quality of the current working frequency channel worsens. In other words, the signal quality of said one of the candidate frequency channels is optimal and is better than that of the current working frequency channel by about 6 dB.

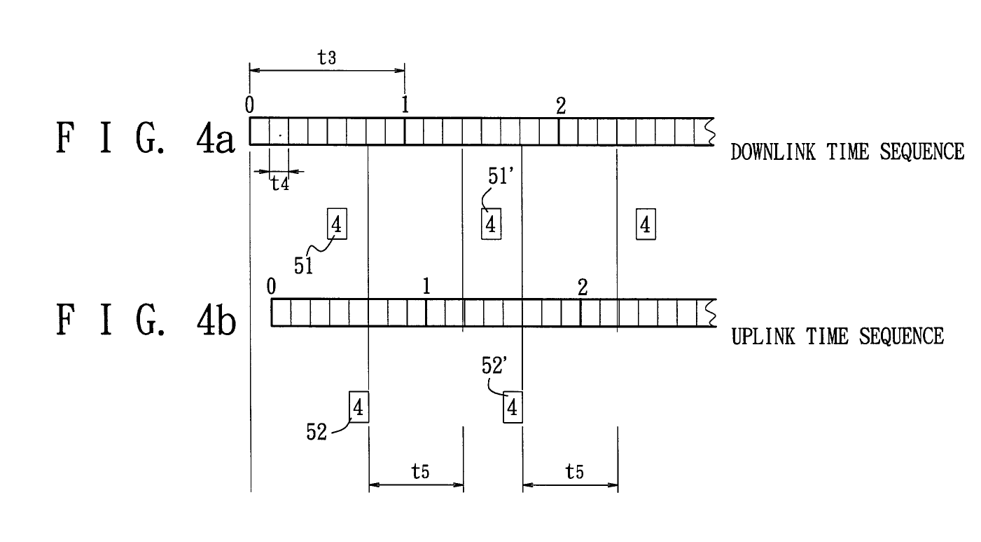

The radio port (not shown) transmits data to the mobile communications device 2 in accordance with a first time sequence, such as a downlink time sequence, defined in a known manner, wherein the downlink time sequence is defined with a plurality of consecutive time frames, each of which has a time interval (t3), such as 2.5 msec. Each time frame is defined with a plurality of time bursts, such as 8 time bursts, each of which has a time interval (t4) (see FIG. 4a). The time bursts of each time frame are indicated by successive serial numbers, such as 0, 1, 2, 3, 4, 5, 6 and 7. As such, the downlink time sequence is defined with a plurality of time-division-multiplexed time slots, each of which consists of the time bursts indicated by the same serial number in the consecutive time frames.

The mobile communications device 2 transmits data to the radio port in accordance with a second time sequence, such as an uplink time sequence, corresponding to the downlink time sequence (see FIG. 4b).

As in the prior art, data transmission between the radio port and the mobile communications device 2 is accomplished in assigned ones of the time slots of the downlink and uplink time sequences.

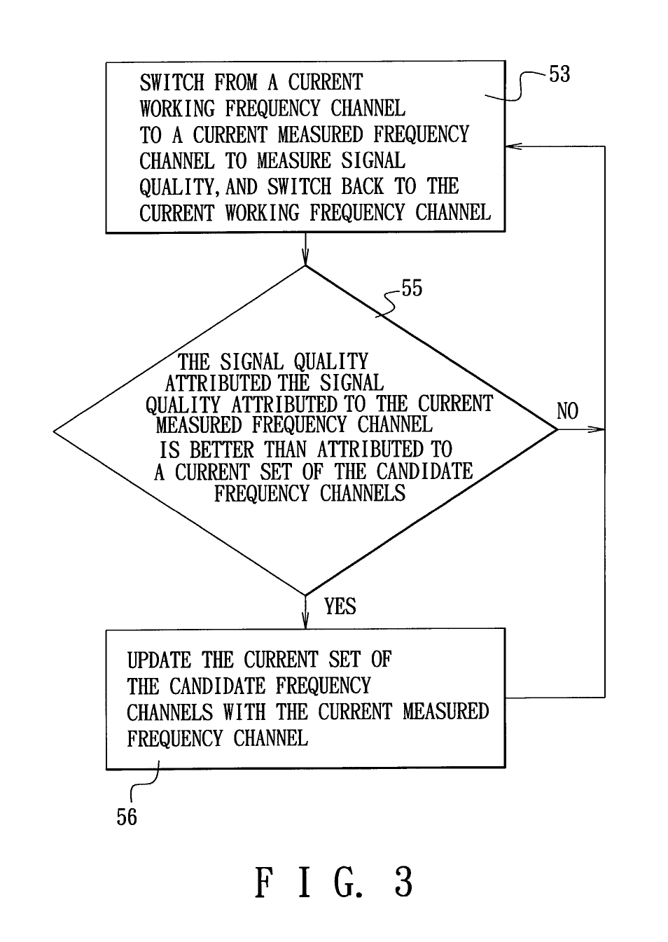

Referring to FIG. 3, there is shown a flow chart to illustrate how the mobile terminal 2 is configured to update a set of candidate frequency channels in accordance with the method of the preferred embodiment. In step 53, the microprocessor 21 enables the radio frequency module 23 to switch from the current working frequency channel to a current measured one of the pre-stored frequency channels, and enables the radio frequency module 23 and the baseband unit 24 to measure signal quality attributed to the current measured one of the pre-stored frequency channels after the assigned one of the time slots of a current one of the time frames of the uplink time sequence, for example, the time slot 52 shown in FIG. 4b, and to switch from the current measured one of the pre-stored frequency channels back to the current working frequency channel prior to the assigned one of the time slots of a succeeding one of the time frames of the first time sequence, for example, the time slot 51′ shown in FIG. 4a. In the example of FIGS. 4a and 4b, the radio frequency module 23 and the baseband unit 24 are able to measure signal quality attributed to the current measured one of the pre-stored frequency channels during a time period (t5). In this embodiment, in order to prevent improper measurement of the signal quality due to fading effect, the signal quality is obtained via a running average. In step 55, the microprocessor 21 verifies whether the signal quality attributed to the current measured one of the pre-stored frequency channels is better than those attributed to the current set of the candidate frequency channels. In step 56, the mobile communications device 2 updates the current set of the candidate frequency channels with the current measured one of the pre-stored frequency channels when the signal quality attributed to the measured one of the pre-stored frequency channels is better than those attributed to the current set of the candidate frequency channels. Otherwise, the flow proceeds back to step 53.

As a result, the method of this invention utilizes an idle time period (t5) to update the set of the candidate frequency channels to obviate the need for additional radio frequency module and baseband unit, thereby resulting in lower costs.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of updating a set of candidate frequency channels during wireless communications between a radio port and a mobile communications device, the mobile communications device being capable of wireless communications using one of a plurality of pre-stored frequency channels having different frequencies within a frequency bandwidth,
the mobile communications device selecting one of the pre-stored frequency channels having optimum signal quality as a current working frequency channel for bi-directional data transmission with the radio port, and further selecting a current set of the remaining pre-stored frequency channels having good signal quality as candidate frequency channels when the mobile communications device is activated, one of the candidate frequency channels being available for use as the working frequency channel when the signal quality of the current working frequency channel worsens,
the radio port transmitting data to the mobile communications device in accordance with a first time sequence defined with a plurality of time-division-multiplexed time slots in consecutive time frames,
the mobile communications device transmitting data to the radio port in accordance with a second time sequence corresponding to the first time sequence,
data transmission between the radio port and the mobile communications device being accomplished in assigned ones of the time slots of the first and second time sequences,
said method comprising the steps of:
(a) enabling said mobile communications device to switch from the current working frequency channel to a current measured one of the pre-stored frequency channels and to measure signal quality after the assigned one of the time slots of a current one of the time frames of the second time sequence, and to switch from the current measured one of the frequency channels back to the current working frequency channel prior to the assigned one of the time slots of a succeeding one of the time frames of the first time sequence;
(b) enabling said mobile communications device to verify whether the signal quality attributed to the current measured one of the pre-stored frequency channels is better than those attributed to the current set of the candidate frequency channels; and
(c) enabling said mobile communications device to update the current set of the candidate frequency channels with the current measured one of the pre-stored frequency channels when the signal quality attributed to the measured one of the frequency channels is better than those attributed to the current set of the candidate frequency channels.

2. The method as claimed in claim 1, wherein each of the pre-stored frequency channels is associated with a specific uplink frequency and a specific downlink frequency.
